(19) United States
(12) Patent Application Publication
(10) Pub. No.: US 2026/0027481 A1
(43) Pub. Date: Jan. 29, 2026

(54) Snap-on quick-release Joy-Con grip

(71) Applicants: Dongguan kufan electronics Co., LTD, Dongguan (CN); Shenzhen Qixun Space Technology Co., LTD, Shenzhen (CN)

(72) Inventor: Shengjun Wang, Wuhan (CN)

(21) Appl. No.: 19/346,898

(22) Filed: Oct. 1, 2025

(30) Foreign Application Priority Data
Aug. 22, 2025 (CN) 202521799386.7

(51) Int. Cl. A63F 13/98; A63F 13/24

(52) U.S. Cl. CPC A63F 13/98; A63F 13/24

(57) ABSTRACT

A snap-on quick-release Joy-Con grip is provided and relates to the technical field of Joy-Con grips. The snap-on quick-release Joy-Con grip includes a main body part. Joy-Con barrier walls are respectively arranged on a left side and a right side of the main body part. Drawer structures are respectively arranged on a front side and a rear side of the main body part. The drawer structures are connected with quick-release components. The quick-release components have Joy-Con pressing structures abutted to the main body part and insertion structures inserted into the drawer structures. The Joy-Con pressing structures and the insertion structures are fixedly connected to each other. An elastic pressing component is arranged at a lower end of the main body part. The elastic pressing component is connected with a T-shaped clamping block extending into the drawer structures.

### TECHNICAL FIELD

The present disclosure relates to the technical field of Joy-Con grips, and in particular, to a snap-on quick-release Joy-Con grip.

### BACKGROUND

In the field of existing game devices, to improve the flexibility of game manipulation, some game consoles, such as a Switch, employ a separable structural design for a Joy-Con and a screen. This separable design allows the Joy-Con to be used alone in a split state or to be combined with the screen to form a complete device for use. This significantly meets game requirements in different scenarios.

To further optimize the operating experience of a player when the player holds the Joy-Con that is in the split state and improve a comfort level of holding, an appropriate grip may be usually provided for such a single-sided Joy-Con in the industry. However, the current grip for fixing the single-sided Joy-Con has significant limitations on the structural design: The current grip predominantly employs an integrated structure, and a fixing manner for the Joy-Con and the grip generally relies on a design thought of forced snapping in.

Although this design can implement fixing of the Joy-Con and the grip, this design has numerous issues in practical use. Due to the diversity of game scenarios, the Joy-Con often needs to switch between a split usage state and a combined usage state. For example, in some games, the Joy-Con needs to be separated for independent operation, while in some other games, the Joy-Con needs to be combined with the screen for operation. In this case, the quick-release performance between the grip and the Joy-Con is particularly crucial. However, in the existing forced snap-in fixing structure, an operation process of fixing or detaching the Joy-Con is cumbersome. This not only affects the operating efficiency, but also may cause wear on the Joy-Con or the grip due to frequent forced snap-in actions, thereby shortening the service life of the device and making it difficult to meet a requirement of a player for convenient operations.

Therefore, for a grip for a detachable Joy-Con, how to break through the limitation of the existing integrated structure and the limitation of the forced snap-in fixing manner to implement quick mount and detach the Joy-Con and the grip has become a technical problem that currently needs to be solved.

### SUMMARY

In order to overcome the drawbacks described above, the present disclosure aims to provide a technical solution capable of solving the above problems.

A snap-on quick-release Joy-Con grip includes a main body part. Joy-Con barrier walls are respectively arranged on a left side and a right side of the main body part. Drawer structures are respectively arranged on a front side and a rear side of the main body part. The drawer structures are connected with quick-release components.

The quick-release components have Joy-Con pressing structures abutted to the main body part and insertion structures inserted into the drawer structures. The Joy-Con pressing structures and the insertion structures are fixedly connected to each other.

An elastic pressing component is arranged at a lower end of the main body part. The elastic pressing component is connected with a T-shaped clamping block extending into the drawer structures. The T-shaped clamping block rises up by driving the elastic pressing component and is reset by rebound of the elastic pressing component.

The T-shaped clamping block has a columnar portion connected to the elastic pressing component and an abutment portion formed on the columnar portion. Open window portions that match the abutment portion are formed in the insertion structures. Position-providing slots corresponding to the columnar portion are formed in sides of the insertion structures that are located at the open window portions. After the T-shaped clamping block rises up, the columnar portion can extend into the position-providing slots.

First springs resisting against the insertion structures are arranged on inner sides of the drawer structures; and the first springs are configured to push the insertion structures to cause the columnar portion to extend into the position-providing slots.

Preferably, open slot structures are formed in front and rear positions of the main body part; the open slot structures penetrate through to the front side and the rear side of the main body part; and cover plates are fixedly covered at the open slot structures, so that the open slot structures are formed into the drawer structures with openings in side portions.

Preferably, a plurality of first guide strips are formed at bottoms of the open slot structures; first guide slots abutted to the first guide strips are formed in lower ends of the insertion structures; a plurality of second guide strips are formed at upper ends of the insertion structures; and second guide slots abutted to the second guide strips are formed in lower end surfaces of the cover plates.

Preferably, a pressing slot that is arched upwards is formed in a lower end of the main body part; a deep hole portion communicated to interiors of the drawer structures is formed in a top of the pressing slot; the elastic pressing component includes a T-shaped pressing piece and a second spring sleeving the T-shaped pressing piece; the T-shaped pressing piece is reversely abutted to the pressing slot; the columnar portion is fixedly connected to the T-shaped pressing piece through the deep hole portion, so that the T-shaped pressing piece and the T-shaped clamping block form an I-shaped structure constrained in the deep hole portion; and the second spring elastically resists against the top of the pressing slot.

Preferably, guide seats that are in position-providing fit with the position-providing slots are further formed at positions, which are located in the deep hole portion, inside the drawer structures; and a movement direction of the T-shaped clamping block is guided through the guide seats.

Preferably, concave plates are respectively formed on the left and right of the open slot structures; the insertion structures are pressed between the two concave plates; limiting blocks erected on the concave plates are formed on two sides of the insertion structures; and insertion portions of the insertion structures restrain a movement stroke through cooperation between the limiting blocks and the concave plates.

Preferably, a functional opening that adapts to a Joy-Con is formed in one Joy-Con barrier wall.

Preferably, an elongated slot that penetrates through upper and lower end surfaces of the main body part is formed in the main body part along the other Joy-Con barrier wall, and an extension portion extends out of a corner of the elongated slot, so that an elastically deformable pulling portion is formed on the main body part along the elongated slot.

Compared with the prior art, the present disclosure has the beneficial effects:

By the snap-on quick-release structural design, the grip effectively solves the problem that it is cumbersome to mount and detach a traditional forced snap-in grip. By virtue of the cooperation between the elastic pressing component and the T-shaped clamping block, locking and unlocking can be implemented by simply performing a pressing operation. In conjunction with an automatic resetting function of the first springs, the efficiency of mounting and detaching the Joy-Con and the grip is greatly improved. Due to the combined design of the Joy-Con barrier walls and the Joy-Con pressing structures, the stability after the Joy-Con is fixed is ensured, and looseness in a gaming process is avoided. The modularized design of the drawer structures and the quick-release components simplifies the overall structure, reduces wear of the components caused by frequent mounting and detaching, and prolongs the service life of the grip. Meanwhile, the snap-on quick-release Joy-Con grip is applicable to various usage scenarios in which a Joy-Con is detached or combined, and operation convenience and a gripping comfort level of a player are significantly improved.

The additional aspects and advantages of the present disclosure will be partially provided in the following descriptions, some of which will become apparent from the following descriptions, or learned through the practice of the present disclosure.

### BRIEF DESCRIPTION OF THE DRAWINGS

To describe the technical solutions in the embodiments of the present disclosure or in the prior art more clearly, the following briefly introduces the accompanying drawings for describing the embodiments or the related art. Apparently, the accompanying drawings in the following description show merely some embodiments of the present disclosure, and a person of ordinary skill in the art may still derive other drawings from the accompanying drawings without creative efforts.

FIG. 1 is a schematic structural diagram of a state of fixing a Joy-Con according to the present disclosure;

FIG. 2 is a schematic structural diagram of a state of releasing a Joy-Con according to the present disclosure;

FIG. 3 is a schematic structural diagram of a state of removing one cover plate in FIG. 2 according to the present disclosure;

FIG. 4 is a partially exploded structural diagram of the present disclosure in a viewing angle;

FIG. 5 is a partially exploded structural diagram of the present disclosure in another viewing angle;

FIG. 6 is a schematic sectional structural diagram of a state of fixing a Joy-Con according to the present disclosure;

FIG. 7 is a schematic sectional structural diagram of a state of releasing a Joy-Con according to the present disclosure; and

FIG. 8 is a schematic structural diagram of a quick-release component and T-shaped clamping block in the present disclosure.

Reference numerals and names in the drawings are as follows:

10: main body part; 101: elongated slot; 102: extension portion; 11: Joy-Con barrier wall; 111: functional opening; 12: open slot structure; 13: cover plate; 14: first guide strip; 15: first guide slot; 16: second guide strip; 17: second guide slot; 18: pressing slot; 19: deep hole portion; 20: drawer structure; 21: first spring; 22: guide seat; 23: concave plate; 30: quick-release component; 31: Joy-Con pressing structure; 32: insertion structure; 33: open window portion; 34: position-providing slot; 35: limiting block; 40: elastic pressing component; 41: T-shaped pressing piece; 42: second spring; 50: T-shaped clamping block; 51: columnar portion; and 52: abutment portion.

### DETAILED DESCRIPTION OF THE EMBODIMENTS

The technical solutions in the embodiments of the present disclosure are clearly and completely described below. Apparently, the described embodiments are merely some embodiments of the present disclosure, rather than all of the embodiments. All other embodiments obtained by a person of ordinary skill in the art based on the embodiments of the present disclosure without making creative efforts shall fall within the protection scope of the present disclosure.

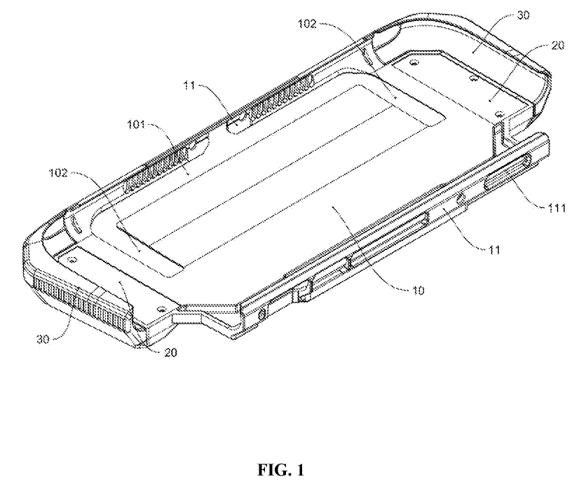

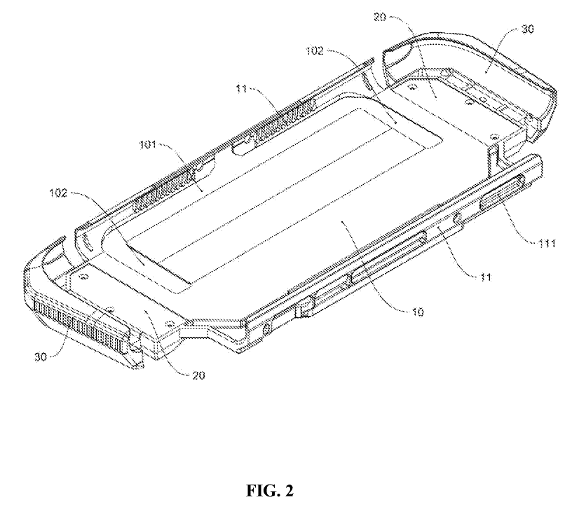

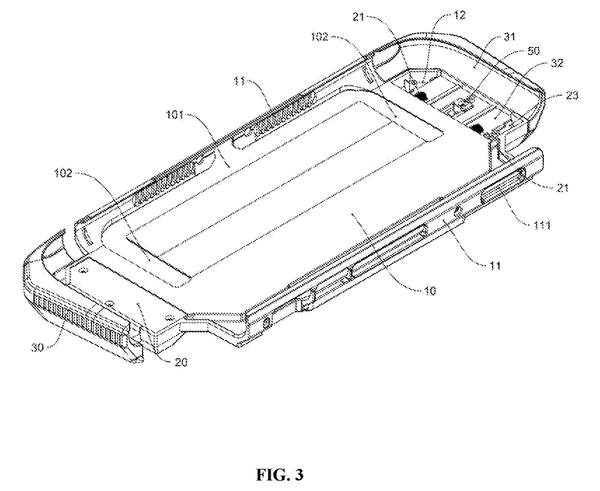

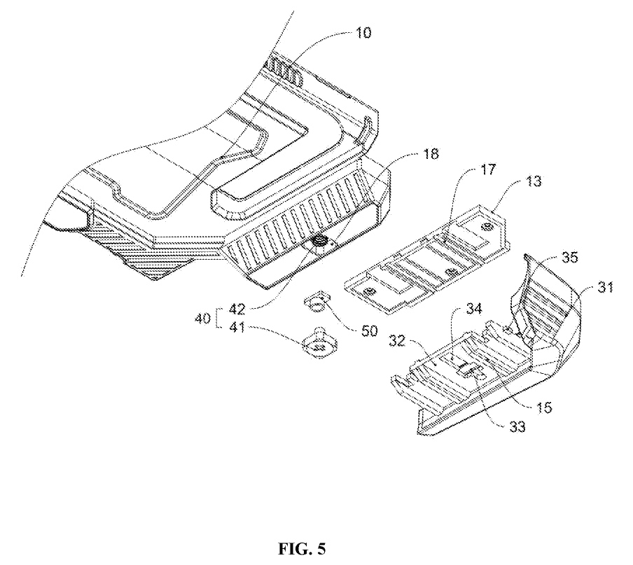

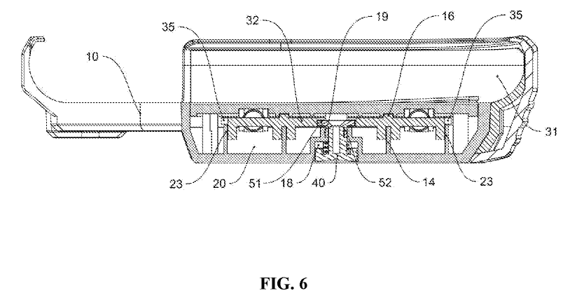

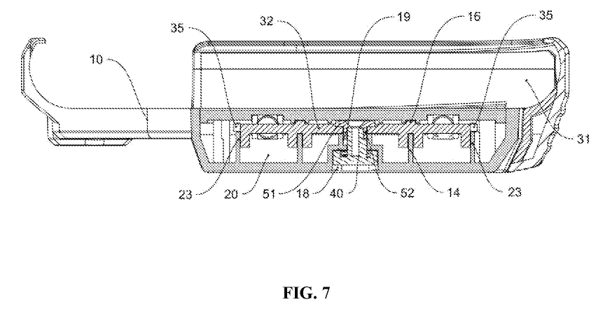

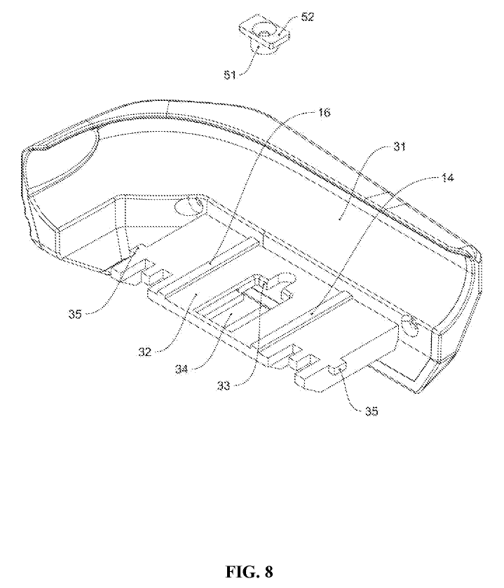

Referring to FIG. 1 to FIG. 8, in this embodiment of the present disclosure, a snap-on quick-release Joy-Con grip includes a main body part 10. Joy-Con barrier walls 11 are respectively arranged on a left side and a right side of the main body part 10. Drawer structures 20 are respectively arranged on a front side and a rear side of the main body part 10. The drawer structures 20 are connected with quick-release components 30.

The quick-release components 30 have Joy-Con pressing structures 31 abutted to the main body part 10 and insertion structures 32 inserted into the drawer structures 20. The Joy-Con pressing structures 31 and the insertion structures 32 are fixedly connected to each other.

An elastic pressing component 40 is arranged at a lower end of the main body part 10. The elastic pressing component 40 is connected with a T-shaped clamping block 50 extending into the drawer structures 20. The T-shaped clamping block 50 rises up by driving the elastic pressing component 40 and is reset by rebound of the elastic pressing component 40.

The T-shaped clamping block 50 has a columnar portion 51 connected to the elastic pressing component 40 and an abutment portion 52 formed on the columnar portion 51. Open window portions 33 that match the abutment portion 52 are formed in the insertion structures 32. Position-providing slots 34 corresponding to the columnar portion 51 are formed in sides of the insertion structures 32 that are located at the open window portions 33. After the T-shaped clamping block 50 rises up, the columnar portion 51 can extend into the position-providing slots 34.

First springs 21 resisting against the insertion structures 32 are arranged on inner sides of the drawer structures 20. The first springs 21 are configured to push the insertion structures 32 to cause the columnar portion 51 to extend into the position-providing slots 34.

The snap-on quick-release Joy-Con grip implements quick fixing and detaching of a Joy-Con through a linked mechanical structure. When the Joy-Con needs to be mounted, the Joy-Con is placed between the Joy-Con barrier walls 11 on the two sides of the main body part 10, and the insertion structures 32 of the quick-release components 30 are pushed to move inwards along the drawer structures 20. In this case, the insertion structures 32 compress the first springs 21 on the inner sides of the drawer structures. After the abutment portion 52 of the T-shaped clamping block 50 corresponds to the open window portions 33 of the insertion structures 32, the elastic pressing component 40 rebounds to drive the T-shaped clamping block 50 to be reset, and the abutment portion 52 of the T-shaped clamping block 50 is snapped into the open window portions 33 to implement locking. Meanwhile, the Joy-Con pressing structures 31 press and fix the Joy-Con. When the Joy-Con needs to be detached, the elastic pressing component 40 drives the T-shaped clamping block 50 to rise up, and the columnar portion 51 is abutted to the position-providing slots 34 of the insertion structures 32. The abutment portion 52 is separated from the open window portions 33. Elastic forces of the first springs 21 push the insertion structures 32 to move outwards along the drawer structure 20. The Joy-Con pressing structures 31 relieve pressing on the Joy-Con, so that the Joy-Con can be quickly removed.

By the snap-on quick-release structural design, the problem that it is cumbersome to mount and detach a traditional forced snap-in grip is effectively solved. By virtue of the cooperation between the elastic pressing component 40 and the T-shaped clamping block 50, locking and unlocking can be implemented by simply performing a pressing operation. In conjunction with an automatic resetting function of the first springs 21, the efficiency of mounting and detaching the Joy-Con and the grip is greatly improved. Due to the combined design of the Joy-Con barrier walls 11 and the Joy-Con pressing structures 31, the stability after the Joy-Con is fixed is ensured, and looseness in a gaming process is avoided. The modularized design of the drawer structures 20 and the quick-release components 30 simplifies the overall structure, reduces wear of the components caused by frequent mounting and detaching, and prolongs the service life of the grip. Meanwhile, the snap-on quick-release Joy-Con grip is applicable to various usage scenarios in which a Joy-Con is detached or combined, and operation convenience and a gripping comfort level of a player are significantly improved.

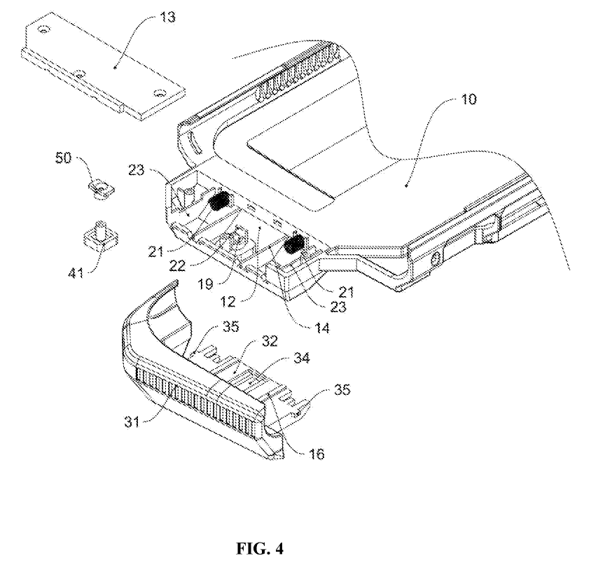

Referring to FIG. 4 to FIG. 8, based on the above technical solution, it further recites that open slot structures 12 are formed in front and rear positions of the main body part 10. The open slot structures 12 penetrate through to the front side and the rear side of the main body part 10. Cover plates 13 are fixedly covered at the open slot structures 12, so that the open slot structures 12 are formed into the drawer structures 20 with openings in side portions. This simplifies machining and assembling procedures of the drawer structures 20, so that the entire main body part 10 can be molded by injection through a simple model design. A plurality of first guide strips 14 are formed at bottoms of the open slot structures 12. First guide slots 15 abutted to the first guide strips 14 are formed in lower ends of the insertion structures 32. A plurality of second guide strips 16 are formed at upper ends of the insertion structures 32. Second guide slots 17 abutted to the second guide strips 16 are formed in lower end surfaces of the cover plates 13. Due to the cooperation between the first guide strips 14 and the first guide slots 15 as well as the cooperation between the second guide strips 16 and the second guide slots 17, upper and lower dual guide structures are formed. This greatly improves the stability and smoothness of the insertion structures 32 during movement in the drawers, avoids blockage or skewing, and ensures the precision of a quick-release operation. Concave plates 23 are respectively formed on the left and right of the open slot structures 12. The insertion structures 32 are pressed between the two concave plates 23. Limiting blocks 35 erected on the concave plates 23 are formed on two sides of the insertion structures 32. Insertion portions of the insertion structures 32 restrain a movement stroke through cooperation between the limiting blocks 35 and the concave plates 23. The movement stroke of the insertion structures 32 can be precisely restrained to prevent component damage or a connection failure caused by excessive movement of the insertion structures. Meanwhile, this further improves the lateral stability of the insertion structures 32 in the movement process, so that the overall structure of the grip is more reliable, and the practicability and durability of a quick-release function are optimized in terms of details.

Referring to FIG. 4 to FIG. 8, based on the above technical solution, it further recites that a pressing slot 18 that is arched upwards is formed in a lower end of the main body part 10. This can implement embedded arrangement of the elastic pressing component 40, ensure the completeness of lines on a surface of the main body part. A deep hole portion 19 communicated to interiors of the drawer structures 20 is formed in a top of the pressing slot 18. The elastic pressing component 40 includes a T-shaped pressing piece 41 and a second spring 42 sleeving the T-shaped pressing piece 41. The T-shaped pressing piece 41 is reversely abutted to the pressing slot 18. The columnar portion 51 is fixedly connected to the T-shaped pressing piece 41 through the deep hole portion 19, so that the T-shaped pressing piece 41 and the T-shaped clamping block 50 form an I-shaped structure constrained in the deep hole portion 19; and the second spring 42 elastically resists against the top of the pressing slot 18. By virtue of an elastic force of the second spring 42, precise rebounding and resetting are implemented, which ensures that locking and unlocking actions on the T-shaped clamping block 50 are reliable and efficient. Furthermore, the deep hole portion 19 effectively constrains the I-shaped structure, so that skewing during the movement of the component is avoided. In addition, guide seats 22 that are in position-providing fit with the position-providing slots 34 are further formed at positions, which are located in the deep hole portion 19, inside the drawer structures 20. A movement direction of the T-shaped clamping block 50 is guided through the guide seats 22. This further guides the movement direction of the T-shaped clamping block 50, reduces movement deviations, and improves the precision of the quick-release operation. Meanwhile, this structural design forms multi-protection on the elastic pressing component 40 and the T-shaped clamping block 50, reduces wear caused by frequent operations, prolongs the service life of an extension portion 102, and overall improves the practicability and durability of the grip.

Referring to FIG. 1 to FIG. 3, based on the above technical solution, it further recites a functional opening 111 that adapts to a Joy-Con is formed in one Joy-Con barrier wall 11. This can precisely avoid a connection structure between the Joy-Con and the main body part 10 of the grip, a charging structure for charging the Joy-Con, or the like, and ensure that all functions can be used normally after the Joy-Con is mounted on the grip. An elongated slot 101 that penetrates through upper and lower end surfaces of the main body part 10 is formed in the main body part 10 along the other Joy-Con barrier wall 11, and an extension portion 102 extends out of a corner of the elongated slot 101, so that an elastically deformable pulling portion is formed on the main body part 10 along the elongated slot 101. Due to the elongated slot 101 formed in the main body part 10 along the other Joy-Con barrier wall 11 and the extension portion 102 extends out of the corner, the pulling portion formed along the elongated slot 101 has an elastic deformation capability, so that it is convenient for a player to quickly place or remove the Joy-Con by pulling this portion.

For those skilled in the art, it is apparent that the present disclosure is not limited to the details of the exemplary embodiments mentioned above, and can be implemented in other specific forms without departing from the spirit or basic features of the present disclosure. Therefore, in any perspective, the embodiments should be regarded as exemplary and non-restrictive. The scope of the present disclosure is limited by the accompanying claims rather than the above description. Therefore, all changes within the meaning and scope of the equivalent conditions of the claims within the present disclosure.

What is claimed is:

1. A snap-on quick-release Joy-Con grip, comprising a main body part (10), wherein Joy-Con barrier walls (11) are respectively arranged on a left side and a right side of the main body part (10); drawer structures (20) are respectively arranged on a front side and a rear side of the main body part (10); the drawer structures (20) are connected with quick-release components (30);
the quick-release components (30) have Joy-Con pressing structures (31) abutted to the main body part (10) and insertion structures (32) inserted into the drawer structures (20); the Joy-Con pressing structures (31) and the insertion structures (32) are fixedly connected to each other;
an elastic pressing component (40) is arranged at a lower end of the main body part (10); the elastic pressing component (40) is connected with a T-shaped clamping block (50) extending into the drawer structures (20); the T-shaped clamping block (50) rises up by driving the elastic pressing component (40) and is reset by rebound of the elastic pressing component (40);
the T-shaped clamping block (50) has a columnar portion (51) connected to the elastic pressing component (40) and an abutment portion (52) formed on the columnar portion (51); open window portions (33) that match the abutment portion (52) are formed in the insertion structures (32); position-providing slots (34) corresponding to the columnar portion (51) are formed in sides of the insertion structures (32) that are located at the open window portions (33); after the T-shaped clamping block (50) rises up, the columnar portion (51) extends into the position-providing slots (34);
first springs (21) resisting against the insertion structures (32) are arranged on inner sides of the drawer structures (20); and the first springs (21) are configured to push the insertion structures (32) to cause the columnar portion (51) to extend into the position-providing slots (34).

2. The snap-on quick-release Joy-Con grip according to claim 1, wherein open slot structures (12) are formed in front and rear positions of the main body part (10); the open slot structures (12) penetrate through to the front side and the rear side of the main body part (10); and cover plates (13) are fixedly covered at the open slot structures (12), so that the open slot structures (12) are formed into the drawer structures (20) with openings in side portions.

3. The snap-on quick-release Joy-Con grip according to claim 2, wherein a plurality of first guide strips (14) are formed at bottoms of the open slot structures (12); first guide slots (15) abutted to the first guide strips (14) are formed in lower ends of the insertion structures (32); a plurality of second guide strips (16) are formed at upper ends of the insertion structures (32); and second guide slots (17) abutted to the second guide strips (16) are formed in lower end surfaces of the cover plates (13).

4. The snap-on quick-release Joy-Con grip according to claim 1, wherein a pressing slot (18) that is arched upwards is formed in a lower end of the main body part (10); a deep hole portion (19) communicated to interiors of the drawer structures (20) is formed in a top of the pressing slot (18); the elastic pressing component (40) comprises a T-shaped pressing piece (41) and a second spring (42) sleeving the T-shaped pressing piece (41); the T-shaped pressing piece (41) is reversely abutted to the pressing slot (18); the columnar portion (51) is fixedly connected to the T-shaped pressing piece (41) through the deep hole portion (19), so that the T-shaped pressing piece (41) and the T-shaped clamping block (50) form an I-shaped structure constrained in the deep hole portion (19); and the second spring (42) elastically resists against the top of the pressing slot (18).

5. The snap-on quick-release Joy-Con grip according to claim 4, wherein guide seats (22) that are in position-providing fit with the position-providing slots (34) are further formed at positions, which are located in the deep hole portion (19), inside the drawer structures (20); and a movement direction of the T-shaped clamping block (50) is guided through the guide seats (22).

6. The snap-on quick-release Joy-Con grip according to claim 2, wherein concave plates (23) are respectively formed on the left and right of the open slot structures (12); the insertion structures (32) are pressed between the two concave plates (23); limiting blocks (35) erected on the concave plates (23) are formed on two sides of the insertion structures (32); and insertion portions of the insertion structures (32) restrain a movement stroke through cooperation between the limiting blocks (35) and the concave plates (23).

7. The snap-on quick-release Joy-Con grip according to claim 1, wherein a functional opening (111) that adapts to a Joy-Con is formed in one Joy-Con barrier wall (11).

8. The snap-on quick-release Joy-Con grip according to claim 1, wherein an elongated slot (101) that penetrates through upper and lower end surfaces of the main body part (10) is formed in the main body part (10) along the other Joy-Con barrier wall (11), and an extension portion (102) extends out of a corner of the elongated slot (101), so that an elastically deformable pulling portion is formed on the main body part (10) along the elongated slot (101).
